(19) United States
(12) Patent Application Publication
(10) Pub. No.: US 2025/0217696 A1
(43) Pub. Date: Jul. 3, 2025

(54) VECTOR EMBEDDINGS ARRAYS WITH TEMPORAL DATA

(71) Applicant: Teradata US, Inc., San Diego, CA (US)

(72) Inventor: Artur Borycki, San Marco, CA (US)

(21) Appl. No.: 18/401,595

(22) Filed: Dec. 31, 2023

(51) Int. Cl. G06N 20/00

(52) U.S. Cl. CPC G06N 20/00

(57) ABSTRACT

A system may include a storage device. The system may further include a plurality of processing node in communication with the storage device. At least one processing node of the plurality of processing nodes may receive a data set from a data source. The at least one processing node may execute a model on the received data set to generate a vector embeddings array representative of the received data. The at least one processing node may identify temporal data associated with the vector embeddings array. The at least one processing node may store the vector embeddings array with the associated temporal data in the storage device. A method and computer-readable medium are also disclosed.

### BACKGROUND

Currently, generative artificial intelligence “AI” has no understanding of time from the perspective of how information was changing or evolving over time. Generative AI models take snapshots of information as input, and, while this provides a string input data set, it also limits the model to perform incremental training without the ability to compare the delta of new data sets or data source in order to see how particular data set or subset has evolved over time. For example, with an image as input, while spatial embedding could be taken of the image as an input with basic metadata that provides a basic definition, it is not showing how the same image evolved over time.

Generative AI may use various input representations to operate, but one advantageous input representation is vector embeddings. Vector embeddings allow an n-dimensional array of elements to represent various types of data such as language or images. However, like other generative AI input, vector embeddings do not have temporal awareness. Without such temporal awareness, the vector embeddings do not have the ability to be queried based on key and time periods.

Because vector embeddings do not have associated temporal data, it would be desirable to include temporal data associated with vector embeddings to allow deeper analyses to be performed via generative AI.

### SUMMARY

According to one aspect of the disclosure, a system may include a storage device. The system may further include a plurality of processing node in communication with the storage device. At least one processing node of the plurality of processing nodes may receive a data set from a data source. The at least one processing node may execute a model on the received data set to generate a vector embeddings array representative of the received data. The at least one processing node may identify temporal data associated with the vector embeddings array. The at least one processing node may store the vector embeddings array with the associated temporal data in the storage device.

According to another aspect of the disclosure, a method may include receiving, with a processor, a data set from a data source. The method may include executing, with the processor, a model on the received data set to generate a vector embeddings array representative of the received data. The method may include identifying, with the processor, temporal data associated with the vector embeddings array. The method may include storing, with the processor, the vector embeddings array with the associated temporal data in a storage device.

According to another aspect of the disclosure, computer-readable medium may be encoded with a plurality instructions executable by a processor. The plurality of instructions may include instructions to receive a data set from a data source. The plurality of instructions may include instructions to execute a model on the received data set to generate a vector embeddings array representative of the received data. The plurality of instructions may include instructions to identify temporal data associated with the vector embeddings array. The plurality of instructions may include instructions to store the vector embeddings array with the associated temporal data in a storage device.

### BRIEF DESCRIPTION OF THE DRAWINGS

The disclosure may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of any example analytic environment using vector embeddings.

FIG. 2 is a block diagram of an example comparison of vector embedding array training sets with temporal data.

FIG. 3 is an operational flow diagram of an example storing of vector embeddings arrays with temporal data.

FIG. 4 is an operational flow diagram of an example of comparing vector embeddings arrays with temporal data training sets.

FIG. 5 is a block diagram of an example analytic environment.

FIG. 6 is a detailed block diagram of a processing node.

FIG. 7 is a detailed block diagram of an optimizer module.

FIG. 8 is a detailed block diagram of a parser module.

### DETAILED DESCRIPTION OF THE FIGURES

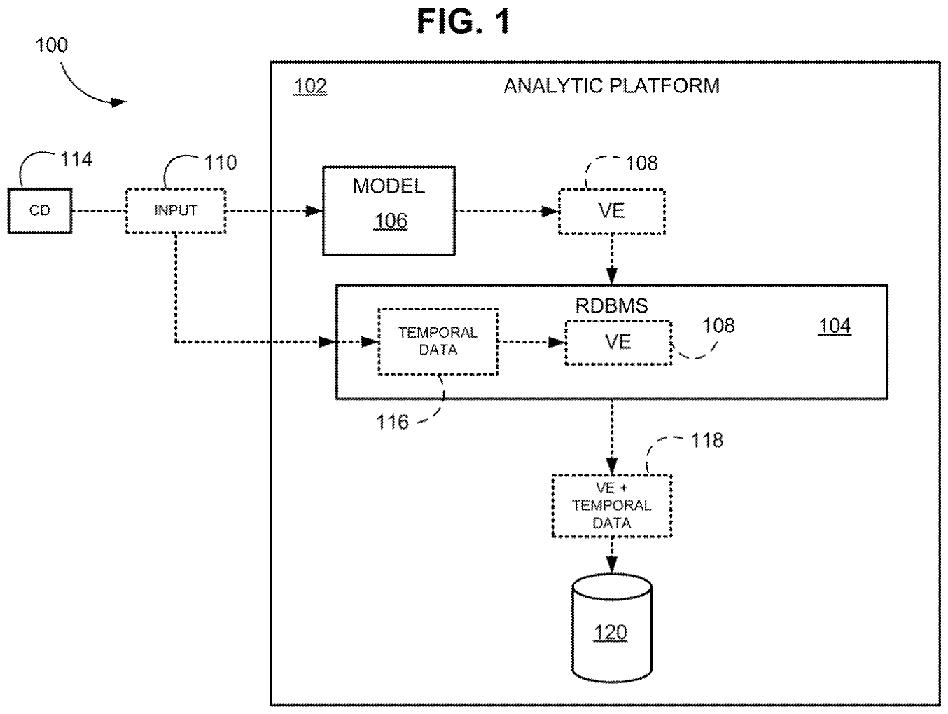

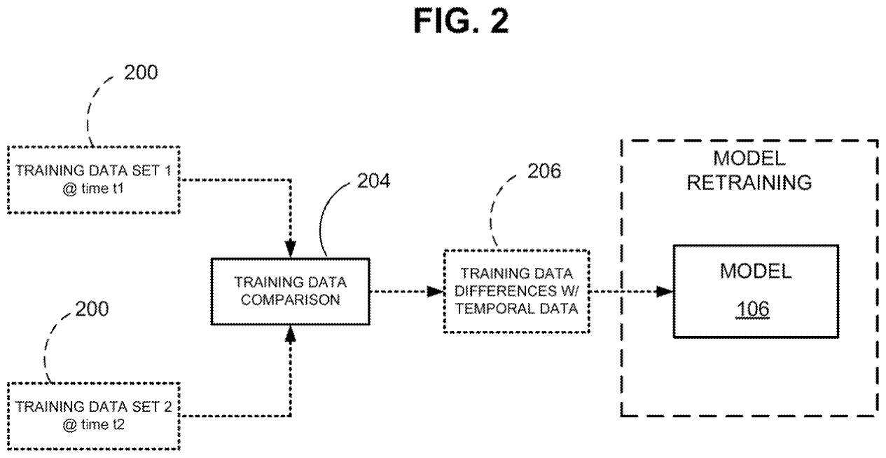

FIG. 1 is block diagram of an example analytic environment 100. In one example, the analytic environment 100 may include an analytic platform (“AP”) 102, such as Teradata Vantage. The analytic platform 102 may include one or more systems that may be used independently or with one another in carrying out advanced analytics. The analytic platform 102 may include a relational database management system (“RDBMS”) 104.

In one example, vector embeddings may be used to model input data in which the vector embeddings can be used by RDBMS 104 or other analysis tool. The analytic platform 102 may include a trained model 106 that may generate one or more vector embeddings arrays 108 based on input 110 received from a client device 114. In one example, vector embeddings arrays may include an n-dimensional array of numbers representative of a given input such that the array may be structured as [e1, e2, . . . en], where “en” is the nth element in the array. Vector embeddings arrays 108 may be received by the RDBMS 104. The RDBMS 104 may also receive the input 110 and gather temporal data 116 from the input 110. The temporal data 116 may represent time-stamp data, such as when the input 110 is created, or other data indicative of the date of creation, receipt, and/or storage. This extracted temporal data 116 may be stored with the associated vector embeddings 108 allowing the vector embeddings with associated temporal data 118 to be stored in the data storage facilities (“DSFs”) 120. In other examples, the model 106 may be integrated into the RDBMS 104.

Model training using vector embedding is a lengthy process. In many instances, a model is re-trained using a full set of vector embeddings data regardless of how much has changed from the prior training. In order to expedite training, temporal data may be used in vector embeddings that are used for model training. In one example, a training data set 200 may include vector embeddings training data taken at a time t1. A second training data set 202 may include vector embedding data at time t2, where t2 is later than t1. The training data sets 200, 202 may undergo a training data comparison 204. Through the comparison, vector embedding data 206 that has changed from time t1 to time t2 may be used to retrain the model 106, which may include the relevant time data so that the model 106 may be trained with temporal awareness of vector embedding changes. Such awareness may allow the model 106 to generate vector embeddings that are dependent on time.

Various types of vector embeddings arrays with temporal data may be stored by an RDBMS, such as the RDBMS 104, in multiple ways allowing robust applications for vector embeddings arrays. For example, dense vector embeddings arrays may be stored with temporal data. Dense vector embeddings arrays, also known as dense vector representations, are vector embeddings arrays where most of the elements are non-zero. Dense vector embeddings arrays typically have a fixed length and each element in the vector carries information about a specific aspect or feature of the object being represented. Dense vector embeddings arrays are commonly used in natural-language processing (NLP) tasks, where words or documents are represented as dense vectors in a high-dimensional space. These dense vector embeddings arrays may capture semantic relationships between words or documents and enable various operations, such as measuring similarity between vectors or performing mathematical operations like vector addition or subtraction.

Temporal data may also be stored with sparse vector embeddings. Sparse vector embeddings arrays are vectors where most of the elements are zero. In this type of embedding, only a few elements contain non-zero values, while the rest remain zero. Sparse vector embeddings arrays are typically used in situations where the input data is highly dimensional, and most of the dimensions are irrelevant or do not carry significant information. By using sparse vector embeddings arrays, computational resources may be conserved since only the non-zero elements need to be stored or processed. Sparse vector embeddings arrays are commonly used in applications like recommendation systems, where user-item interactions are represented as sparse embeddings vectors, and dimensionality reduction techniques like matrix factorization or collaborative filtering are employed to learn useful patterns and make recommendations.

Vector embeddings may also allow flexible storage with temporal data such that different storage formats are utilized. In one example, vector embeddings arrays may be stored as independent columns in an RDBMS or as native data types for individual columns in an RDBMS. Table I below indicates a manner of format in which vector embeddings may be stored with temporal data.

TABLE 1

| Column name | Type | Comment |
|---|---|---|
| Vector_id | String | |
| Raw_id | Number | |
| Value_1 | Type defined by vector | For sparse embeddings type can be |
| | metadata as part of | provided by user process if it is not |
| | loading process | provided as part of the input vector |
| | | details |
| Value_(n) | Type defined by vector | For sparse embeddings type can be |
| | metadata as part of | provided by user process if it is not |
| | loading process | provided as part of the input vector |
| | | details |
| Metadata | JSON | Flexible storage of metadata payload, |
| | | with ability to use dot notation to access |
| | | underlining details |
| St_start | Start date (timezone) | System or user generated start date |
| St_end | End date (timezone) | System or user generated start date, null |
| | | if this is current record |
| Period | Derive period complex | PERIOD FOR SYSTEM_TIME(st_start, |
| | data type | st_end) |

As indicated in Table 1, a vector embedding may include call-outs to indicate the ID of the vector, as well as a raw ID indicating the vector string is number-based. Each element of the vector embedding array of dimension n may each be stored in an independent column. Metadata may be stored in individual column as JSON-based data. A start date “St start” and end date “St_end” may be stored as individual columns and indicate the window of time over which the vector embedding array is stored. The “Period” individual column may indicate a time duration between start and end times.

In another example, vector embeddings arrays may each be stored in a single column of a row with temporal data. Vector embeddings arrays may be stored raw as a single flexible column. In this configuration, storage will have read functioning that will support defining data types dynamically to allow consumption of the embeddings. An example of the structure is shown in Table 2.

TABLE 2

| Column name | Type | Comment |
|---|---|---|
| Vector_id | String | |
| Vector | ARRAY or JSON | |
| Vector_type | String | Defines datatype for values store in the |
| | | vector |
| Metadata | JSON | |
| St_start | start date (timezone) | System or user generated start date |
| St_end | end date (timezone) | System or user generated start date, null |
| | | if this is current record |
| Period | Derive period complex | PERIOD FOR SYSTEM_TIME(st_start, |
| | data type | st_end) |

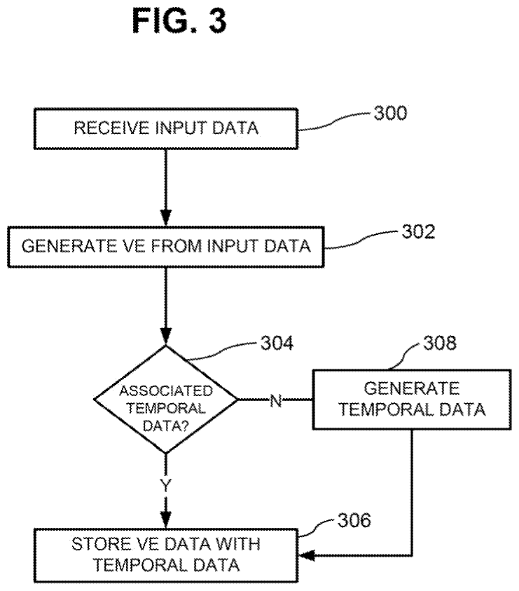

FIG. 3 is an operational flow diagram of example intake and storage of vector embedding data with temporal data (300). In one example, input 110 may be received by the model 106 (302). Vector embeddings data, such as vector embeddings arrays, may be generated by the model 106 (304). A determination may be made as to whether or not the vector embedding data includes temporal data (306). If the temporal data is included, the vector embeddings data may be stored with the temporal data (308). If temporal data is not included, system-generated temporal data may be created, such as by the RDBMS 104 (310). Once created, the vector embeddings data may be stored with the temporal data (308).

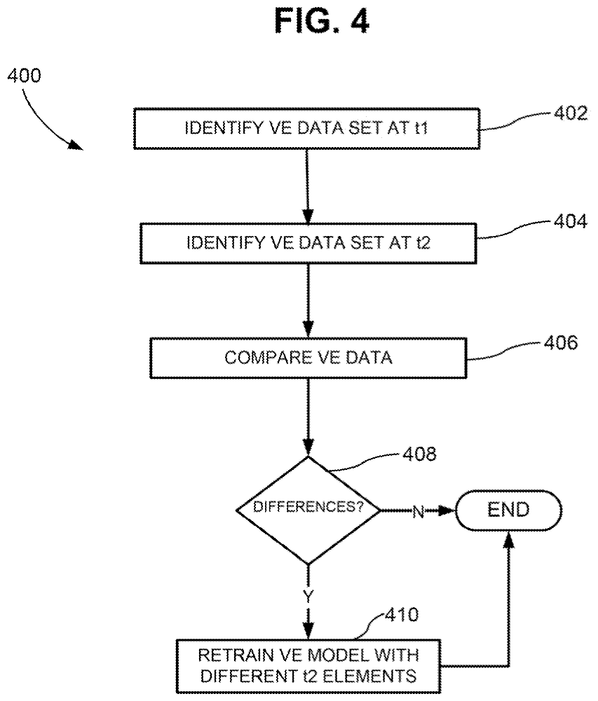

FIG. 4 is an operational flow diagram of an example retraining of a model based on vector-embeddings temporal changes (400). In one example, a vector embedding data set may be identified at a time t1 (402). The vector embedding data set may be identified at a later time, t2 (404). The vector embedding data sets may be compared (406). If any differences between the vector embeddings data sets are identified (408), the elements of the vector embeddings data set that have changed from time t1 to time 12 may be used in a retraining of the model (410).

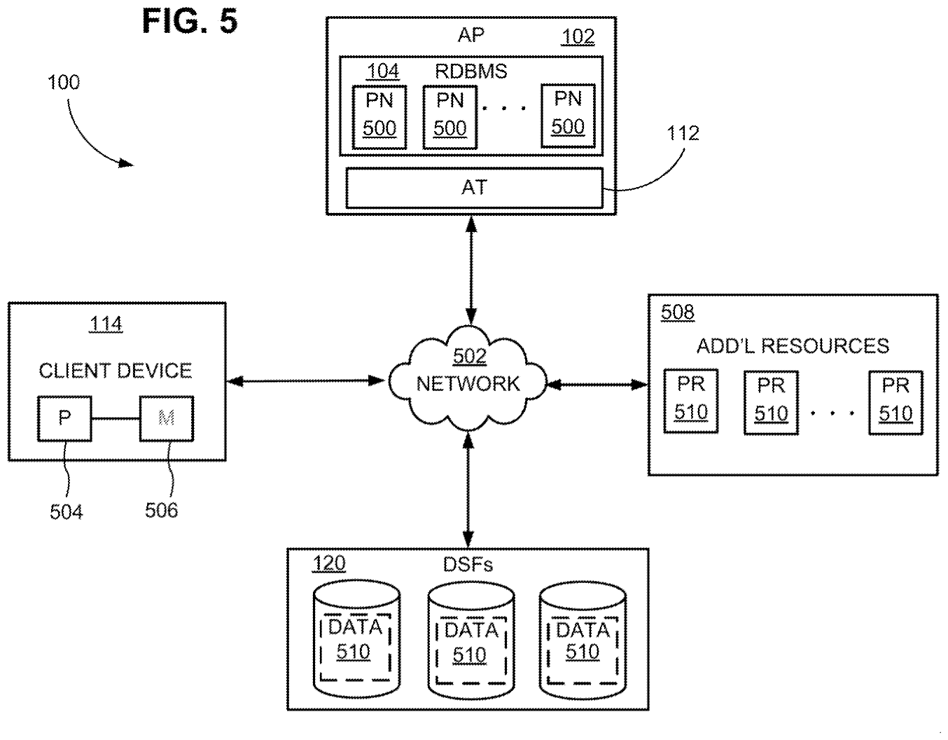

FIG. 5 is block diagram of an example of the analytic environment 100 and the analytic platform (“AP”) 102, such as Teradata Vantage. The analytic platform 102 may include one or more systems that may be used independently or with one another in carrying out advanced analytics. The analytic platform 102 may include the relational database management system (“RDBMS”) 104. In one example, the RDBMS 104 may implement a parallel-processing environment to carry out database management. The RDBMS 104 may be a combination of software (e.g., computer program routines, subroutines, applications, etc.) and hardware (e.g., processors, memory, etc.). In the example of FIG. 5, the RDBMS 104 may be a massively parallel processing (MPP) system having a number of processing nodes 500. In alternative examples, the RDBMS 104 may implement a single processing node, such as in a symmetric multiprocessing (SMP) system configuration. The RDBMS 104 may include one or more processing nodes 500 used to manage the storage, retrieval, and manipulation of data in data storage facilities (DSFs) 120. The processing nodes 500 may manage the storage, retrieval, and manipulation of data included in a database.

The analytic environment 100 may include the client device 114 that communicates with the analytic platform 102 via a network 502. The client device 114 may represent one or more devices, such as a graphical user interface (“GUI”), that allows user input to be received. The client device 114 may include one or more processors 504 and memory (ies) 506. The network 502 may be wired, wireless, or some combination thereof. The network 502 may be a cloud-based environment, virtual private network, web-based, directly-connected, or some other suitable network configuration. In one example, the client device 114 may run a dynamic workload manager (DWM) client (not shown).

In one example, the analytic platform 102 may also include additional resources 508. Additional resources 508 may include processing resources (“PR”) 510. In a cloud-based network environment, the additional resources 508 may represent additional processing resources that allow the analytic platform 102 to expand and contract processing capabilities as needed. The analytic platform 102 may also include analytic tools 512, which may be used independently or in conjunction with the RDBMS 104 and/or the addition resources 508.

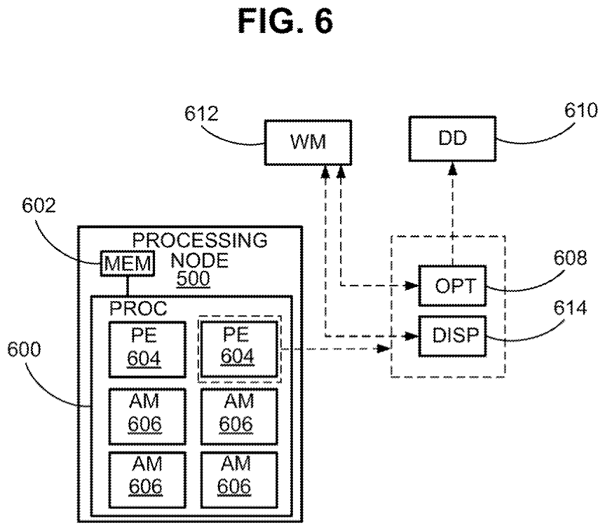

FIG. 6 is an example of a processing node 500, which may include one or more physical processors 600 and memory(ies) 602. The memory 602 may include one or more memories and may be computer-readable storage media or memories, such as a cache, buffer, random access memory (RAM), removable media, hard drive, flash drive or other computer-readable storage media. Computer-readable storage media may include various types of volatile and nonvolatile storage media. Various processing techniques may be implemented by the processors 600 such as multiprocessing, multitasking, parallel processing, and the like, for example.

The processing nodes 500 may include one or more other processing unit types such as parsing engine (PE) modules 604 and access modules (AM) 606. As described herein, each module, such as the parsing engine modules 604 and access modules 606, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively, or in addition, each module may include memory hardware, such as a portion of the memory 602, for example, that includes instructions executable with the processor 600 or other processor to implement one or more of the features of the module. When any one of the modules includes the portion of the memory that comprises instructions executable with the processor, the module may or may not include the processor. In some examples, each module may just be the portion of the memory 602 or other physical memory that comprises instructions executable with the processor 600 or other processor to implement the features of the corresponding module without the module including any other hardware. Because each module includes at least some hardware even when the included hardware comprises software, each module may be interchangeably referred to as a hardware module, such as the parsing engine hardware module or the access hardware module. The access modules 206 may be access modules processors (AMPs), such as those implemented in the Teradata Active Data Warehousing System®.

The parsing engine modules 604 and the access modules 606 may each be virtual processors (vprocs) and/or physical processors. In the case of virtual processors, the parsing engine modules 604 and access modules 606 may be executed by one or more physical processors, such as those that may be included in the processing nodes 500. For example, in FIG. 6, each parsing engine module 604 and access module 606 is associated with a respective processing node 500 and may each be executed as one or more virtual processors by physical processors 600 included in the respective processing node 500.

In FIG. 6, each processing node 500 is shown as including multiple parsing engine modules 604 and access modules 506, such that there are more parsing engine modules 504 and access modules 606 than processing nodes 500. In one example, during operation, the one or more physical processors 600 included in the processing nodes 500 may execute the parsing engine modules 604 and access modules 606 by switching between the executions of the various modules at a rapid rate allowing the vprocs to substantially operate in “parallel.”

The RDBMS 104 stores data 510, such as vector embeddings arrays 108 and associated temporal data 116, in one or more tables in the DSFs 120. In one example, the data 510 may be represent rows of stored tables that are distributed across the DSFs 120 and in accordance with their primary index. The primary index defines the columns of the rows that are used for calculating a hash value. The function that produces the hash value from the values in the columns specified by the primary index is called the hash function. Some portion, possibly the entirety, of the hash value is designated a “hash bucket.” The hash buckets are assigned to DSFs 120 and associated access modules 500 by a hash bucket map. The characteristics of the columns chosen for the primary index determine how evenly the rows are distributed.

Rows of each stored table may be stored across multiple DSFs 120. Each parsing engine module 604 may organize the storage of data and the distribution of table rows. The parsing engine modules 604 may also coordinate the retrieval of data from the DSFs 120 in response to queries received, such as those received from the client device 114 connected to the RDBMS 104 through connection with a network 502.

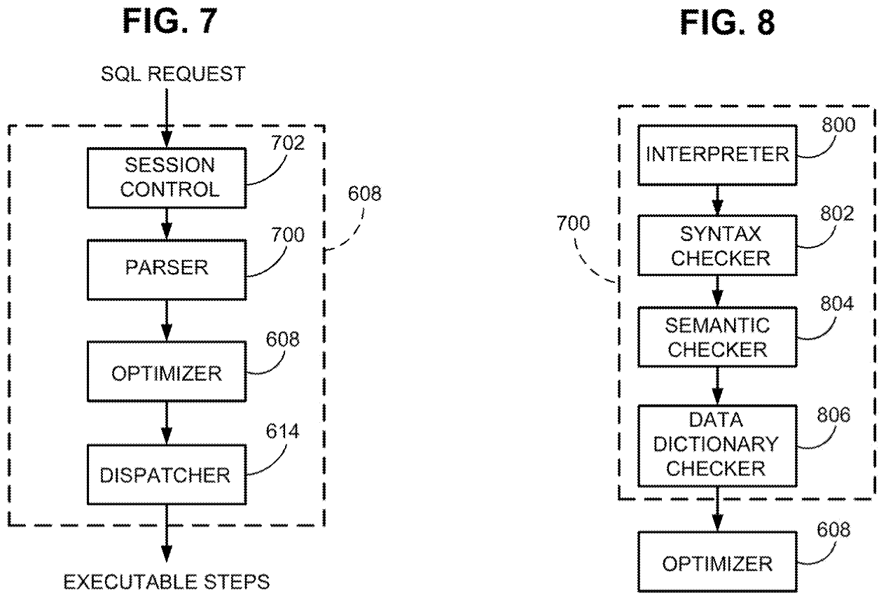

Each parsing engine module 604, upon receiving an incoming database query may apply an optimizer module 608 to assess the best plan for execution of the query. An example of an S optimizer module 608 is shown in FIG. 6 with regard to a parsing engine module 604. Additional description of the parsing engine modules 604 is provided with regard to FIGS. 7 and 8. Selecting the optimal query-execution plan may include, among other things, identifying which of the processing nodes 500 are involved in executing the query and which database tables are involved in the query, as well as choosing which data-manipulation techniques will serve best in satisfying the conditions of the query. To this end, for each parsing engine module 604, a parser module 700 (see FIG. 7), and/or optimizer module 608 may access a data dictionary module 610, shown in FIG. 6 specifically for parsing engine module 108 for purposes of illustration.

The data dictionary module 610 may specify the organization, contents, and conventions of one or more databases, such as the names and descriptions of various tables maintained by the RDBMS 104 as well as fields/columns of each database, for example. Further, the data dictionary module 610 may specify the type, length, and/or other various characteristics of the stored tables. The RDBMS 104 typically receives queries in a standard format, such as the structured query language (SQL) put forth by the American National Standards Institute (ANSI). However, other languages and techniques, such as contextual query language (CQL), data mining extensions (DMX), and multidimensional expressions (MDX), graph queries, analytical queries, machine learning (ML), large language models (LLM) and artificial intelligence (AI), for example, may be implemented in the RDBMS 104 separately or in conjunction with SQL. The data dictionary 610 may be stored in the DSFs 120 or some other storage device and selectively accessed.

The RDBMS 104 may include a workload management system workload management (WM) module 612. The WM module 612 may be implemented as a “closed-loop” system management (CLSM) architecture capable of satisfying a set of workload-specific goals. In other words, the RDBMS 104 is a goal-oriented workload management system capable of supporting complex workloads and capable of self-adjusting to various types of workloads. The WM module 612 may communicate with each optimizer module 608, as shown in FIG. 6, and is adapted to convey a confidence threshold parameter and associated parameters to the optimizer module 608 in communication. Further, the WM module 612 may communicate with a dispatcher module 614 of each parsing engine module 500 (as shown in detail in FIG. 6 for parsing engine module 606) to receive query execution plan costs therefrom, and to facilitate query exception monitoring and automated modifications of confidence threshold parameters in accordance with disclosed embodiments.

The WM module 612 operation has four major phases: 1) assigning a set of incoming request characteristics to workload groups, assigning the workload groups to priority classes, and assigning goals (referred to as Service Level Goals or SLGs) to the workload groups; 2) monitoring the execution of the workload groups against their goals; 3) regulating (e.g. adjusting and managing) the workload flow and priorities to achieve the SLGs; and 4) correlating the results of the workload and taking action to improve performance. In accordance with disclosed embodiments, the WM module 612 is adapted to facilitate control of the optimizer module 208 pursuit of robustness with regard to workloads or queries.

An interconnection (not shown) allows communication to occur within and between each processing node 500. For example, implementation of the interconnection provides media within and between each processing node 500 allowing communication among the various processing units. Such communication among the processing units may include communication between parsing engine modules 604 associated with the same or different processing nodes 606, as well as communication between the parsing engine modules 604 and the access modules 606 associated with the same or different processing nodes 500. Through the interconnection, the access modules 606 may also communicate with one another within the same associated processing node 500 or other processing nodes 500.

The interconnection may be hardware, software, or some combination thereof. In instances of at least a partial-hardware implementation the interconnection, the hardware may exist separately from any hardware (e.g., processors, memory, physical wires, etc.) included in the processing nodes 106 or may use hardware common to the processing nodes 106. In instances of at least a partial-software implementation of the interconnection, the software May be stored and executed on one or more of the memories 502 and processors 504 of the processing nodes 500 or may be stored and executed on separate memories and processors that are in communication with the processing nodes 500. In one example, the interconnection may include multi-channel media such that if one channel ceases to properly function, another channel may be used. Additionally, or alternatively, more than one channel may also allow distributed communication to reduce the possibility of an undesired level of communication congestion among processing nodes 500.

In one example system, each parsing engine module 606 includes three primary components: a session control module 702, a parser module 700, and the dispatcher module 614 as shown in FIG. 7. The session control module 702 provides the logon and logoff functions. It accepts a request for authorization to access the database, verifies it, and then either allows or disallows the access. Once the session control module 702 allows a session to begin, a SQL request may be received such as through submission by a user and the SQL request is routed to the parser module 700.

As illustrated in FIG. 8, the parser module 700 may include an interpreter module 800 that interprets the SQL request. The parser module 700 may also include a syntax checker module 802 that checks the request for correct SQL syntax, as well as a semantic checker module 804 that evaluates the request semantically. The parser module 700 may additionally include a data dictionary checker 806 to ensure that all of the objects specified in the SQL request exist and that the user has the authority to perform the request. The parsing engine module 504 implements the optimizer module 608 to select the least expensive plan to perform the request, and the dispatcher 614 coordinates the runtime execution of executable steps of the query execution plan of the optimizer module 208 with the access modules 206.

In one example, to facilitate implementations of automated adaptive query execution strategies, such as the examples described herein, the WM module 612 monitoring takes place by communicating with the dispatcher module 614 as it checks the query execution step responses from the access modules 606. The step responses include the actual cost information, which the dispatcher module 614 may then communicate to the WM module 612 which, in turn, compares the actual cost information with the estimated costs of the optimizer module 608.

While various embodiments of the disclosure have been described, it will be apparent to those of ordinary skill in the art that many more embodiments and implementations are possible within the scope of the disclosure. Accordingly, the disclosure is not to be restricted except in light of the attached claims and their equivalents.

I claim:

1. A system comprising:
a storage device; and
a plurality of processing node in communication with the storage device, wherein at least one processing node of the plurality of processing nodes is configured to:
receive a data set from a data source;
execute a model on the received data set to generate a vector embeddings array representative of the received data;
identify temporal data associated with the vector embeddings array; and
store the vector embeddings array with the associated temporal data in the storage device.

2. The system of claim 1, wherein the associated temporal data comprises a start time and end time for each vector embeddings array.

3. The system of claim 1, wherein the at least one processing node is configured to:
store each element of the vector embeddings array as a single column of a common row; and
store the associated temporal data in the same common row.

4. The system of claim 1, wherein the at least one processing node is configured to:
store the vector embeddings array as a single column; and
store the associated temporal data in a common row of the vector embeddings array.

5. The system of claim 1, wherein the at least one processing nodes is configured to:
receive a first training data set that comprises first vector embeddings array with associated temporal data;
receive a second training data set that comprises second vector embeddings array with associated temporal data, and wherein the second training data set is based on a time later than the first training data set;
compare common elements of the first vector embeddings array and the second vector embeddings array;
identify common elements that have changed from the first vector embeddings array to the second vector embeddings array based on respective associated temporal data; and
retrain the model using the identified common elements that have changed from the first from the first vector embeddings array to the second vector embeddings array, wherein common elements that have not changed are not included to retrain the model.

6. The system of claim 1, wherein the vector embeddings array is a sparse vector embeddings array.

7. The system of claim 1, wherein the vector embeddings array is a dense vector embeddings array.

8. A method comprising:
receiving, with a processor, a data set from a data source;
executing, with the processor, a model on the received data set to generate a vector embeddings array representative of the received data;
identifying, with the processor, temporal data associated with the vector embeddings array; and
storing, with the processor, the vector embeddings array with the associated temporal data in a storage device.

9. The method of claim 8, wherein the associated temporal data comprises a start time and end time for each vector embeddings array.

10. The method of claim 8, further comprising:
storing, with the processor, each element of the vector embeddings array as a single column of a common row; and
storing, with the processor, the associated temporal data in the same common row.

11. The method of claim 8, further comprising:
storing, with the processor, the vector embeddings array as a single column; and
storing, with the processor, the associated temporal data in a common row of the vector embeddings array.

12. The method of claim 8, further comprising:
receiving, with the processor, a first training data set that comprises first vector embeddings array with associated temporal data;
receiving, with the processor, a second training data set that comprises second vector embeddings array with associated temporal data, and wherein the second training data set is based on a time later than the first training data set;
comparing, with the processor, common elements of the first vector embeddings array and the second vector embeddings array;
identifying, with the processor, common elements that have changed from the first vector embeddings array to the second vector embeddings array based on respective associated temporal data; and
retraining, with the processor, the model using the identified common elements that have changed from the first from the first vector embeddings array to the second vector embeddings array, wherein common elements that have not changed are not included to retrain the model.

13. The method of claim 8, wherein the vector embeddings array is a sparse vector embeddings array.

14. The method of claim 8, wherein the vector embeddings array is a dense vector embeddings array.

15. A computer-readable medium encoded with a plurality instructions executable by a processor, the plurality of instructions comprising:
instructions to receive a data set from a data source;
instructions to execute a model on the received data set to generate a vector embeddings array representative of the received data;
instructions to identify temporal data associated with the vector embeddings array; and
instructions to store the vector embeddings array with the associated temporal data in a storage device.

16. The computer-readable medium of claim 15, wherein the associated temporal data comprises a start time and end time for each vector embeddings array.

17. The computer-readable medium of claim 15, the plurality of instructions further comprising:
instructions to store each element of the vector embeddings array as a single column of a common row; and
instructions to store the associated temporal data in the same common row.

18. The computer-readable medium of claim 15, the plurality of instructions further comprising:
instructions to store the vector embeddings array as a single column; and
instructions to store the associated temporal data in a common row of the vector embeddings array.

19. The computer-readable medium of claim 15, the plurality of instructions further comprising:
instructions to receive a first training data set that comprises first vector embeddings array with associated temporal data;
instructions to receive a second training data set that comprises second vector embeddings array with associated temporal data, and wherein the second training data set is based on a time later than the first training data set;
instructions to compare common elements of the first vector embeddings array and the second vector embeddings array;
instructions to identify common elements that have changed from the first vector embeddings array to the second vector embeddings array based on respective associated temporal data; and
instructions to retrain the model using the identified common elements that have changed from the first from the first vector embeddings array to the second vector embeddings array, wherein common elements that have not changed are not included to retrain the model.

20. The computer-readable medium of claim 15, wherein the vector embeddings array is one of a sparse vector embeddings array and a dense vector embeddings array.
